(19) United States
(12) Patent Application Publication
(10) Pub. No.: US 2010/0151866 A1
(43) Pub. Date: Jun. 17, 2010

(54) METHOD AND SYSTEM FOR ROUTING INTER-CARRIER MESSAGING APPLICATION TRAFFIC VIA A CARRIER-ASSIGNED IDENTIFIER

(75) Inventors: Sergei Karpov, Concord, CA (US); Ye Huang, San Ramon, CA (US)

Correspondence Address: VERIZON;PATENT MANAGEMENT GROUP, 1320 North Court House Road, 9th Floor, ARLINGTON, VA, 22201-2909, US

(73) Assignee: VERIZON CORPORATE SERVICES GROUP INC., Basking Ridge, NJ (US)

(21) Appl. No.: 12/335,879

(22) Filed: Dec. 16, 2008

(51) Int. Cl. H04W 40/00

(52) U.S. Cl. 455/445

(57) ABSTRACT

An approach is provided for routing inter-carrier messaging traffic between a messaging application on a first carrier and a messaging device on a second carrier using a carrier-assigned identifier.

### BACKGROUND INFORMATION

Telecommunication carriers have been experiencing a rapid growth of messaging traffic. However, a number of limitations exist that hinder users from fully exploiting this technology. First, current regulations do not permit communication service providers to offer applications that send messaging traffic directly to devices on networks owned by other service providers. Second, the provisioning process for such services is cost prohibitive and complex.

Therefore, there is a need for an approach that provides for efficient and secure inter-carrier routing of messaging traffic between an application and a messaging device.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of routing inter-carrier messaging application traffic via a carrier-assigned identifier, according to an exemplary embodiment;

FIG. 2 is a diagram of the components of an inter-carrier messaging application platform, according to an exemplary embodiment;

FIG. 3 is a flowchart of a process for assigning an carrier-assigned identifier to a messaging application, according to an exemplary embodiment;

FIG. 4 is a flowchart of a process for routing inter-carrier messaging application traffic via a carrier-assigned identifier, according to an exemplary embodiment;

FIG. 5 is a flowchart of a process for sending messaging traffic from a messaging application, according to an exemplary embodiment;

FIG. 6 is a flowchart of a process for interacting with an inter-carrier messaging application, according to an exemplary embodiment; and

FIG. 7 is a diagram of a computer system that can be used to implement various exemplary embodiments.

### DESCRIPTION OF THE PREFERRED EMBODIMENT

A preferred apparatus, method, and system for routing inter-carrier messaging application traffic via a carrier-assigned identifier are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to messaging traffic between multiple carrier networks, it is contemplated that these embodiments have applicability to other media (e.g., audio, images, video, multi-media, etc.) and other types of networks (e.g., local area networks, proprietary networks, etc.). Further, it is contemplated that the messaging traffic discussed with respect to exemplary embodiments may include short message service (SMS) messaging, multimedia messaging service (MMS) messaging, and/or other similar messaging services.

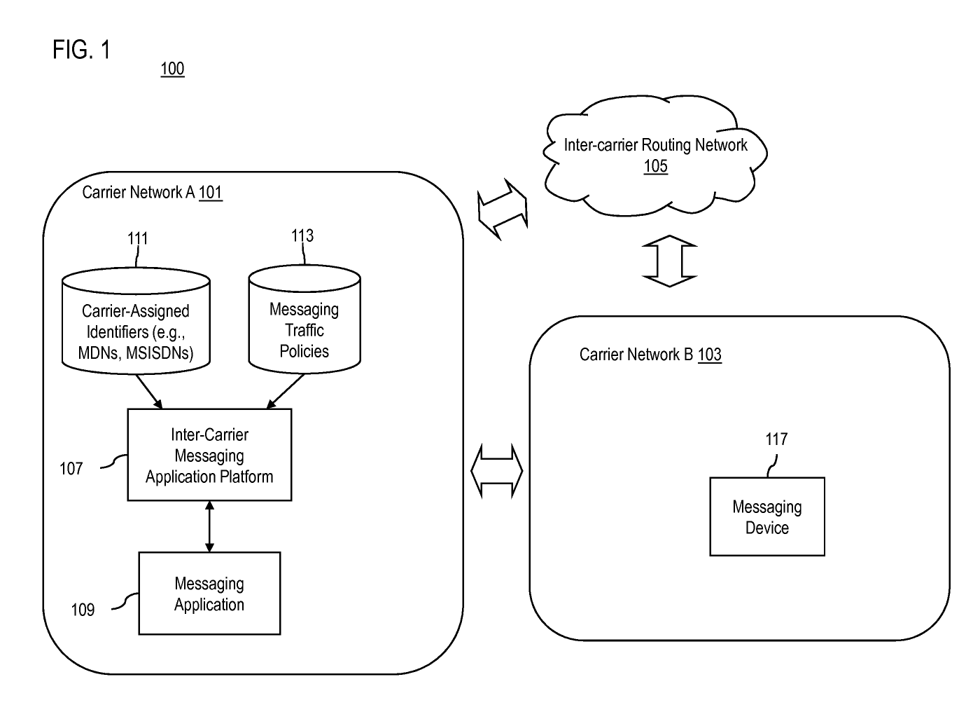

FIG. 1 is a diagram of a system capable of routing inter-carrier messaging application traffic via a carrier-assigned identifier, according to an exemplary embodiment. For the purposes of illustration, a mechanism for routing inter-carrier messaging application traffic is described with respect to a communication system 100 that includes a carrier network A 101 that communicates with another carrier network B 103. Carrier networks 101 and 103 may be connected via a standard inter-carrier routing network 105. This routing network 105, for instance, may be operated by a third party (e.g., a Sybase 365® system) to route inter-carrier messaging traffic to the appropriate destination carrier network. Alternatively, carrier network A 101 may have direct connectivity to carrier network B 103.

It is contemplated that carrier networks 101 and 103 may be cellular networks operated by different service providers and may employ various technologies including, for example, code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like.

Conventional telecommunication industry guidelines, e.g., promulgated by Cellular Telecommunications & Internet Association (CTIA), provide no capability for different wireless carriers to offer messaging applications whereby messaging traffic can be directly exchanged between such applications and devices on other carrier networks. Instead, organizations that want to implement inter-carrier messaging applications must use third party service aggregators (e.g., SMS aggregators) and content providers that are not bound by CTIA guidelines. CTIA members have recognized that these guidelines have prevented many organizations (e.g., businesses, universities, government agencies, etc.) from taking full advantage of messaging applications because of the cumbersome third-party service enablement process.

As messaging traffic between messaging applications and messaging devices increase, drawbacks in the traditional approach for inter-carrier routing of messaging application traffic become even more apparent. Traditionally, routing of messaging application traffic relies on a single central organization to assign a 5-6 digit common short code (CSC) to a messaging application. Once a CSC is assigned, the messaging application provider then either negotiates individually with each wireless carrier or contracts with a third party service aggregator to ensure that messaging traffic from each service provider can be routed to the messaging application using the assigned CSC. This CSC routing process has a number of problems: (1) the process can be costly and complicated to provision on a carrier's network, (2) the process is dependent on one central administrative body, (3) the number of available CSCs is limited, and (4) tracking and ensuring the security of messaging traffic is difficult.

According to one embodiment, the system 100 includes an inter-carrier messaging application platform 107 for routing inter-carrier messaging traffic between a messaging application (e.g., messaging application 109 in carrier network A 101) and a device (e.g., messaging device 117 in carrier network B 103). By way of example, the inter-carrier messaging application platform 107 resides in carrier network A 101. Alternatively, platform 107 may reside in carrier network B 103, within customer premises equipment (CPE) (not shown), and/or across multiple network components.

The inter-carrier messaging application platform 107 enables inter-carrier routing by assigning an identifier (e.g., a mobile directory number (MDN) or a mobile subscriber ISDN (Integrated Services Digital Network) Number (MSISDN)) defined within carrier network A 101 to messaging application 109. In exemplary embodiments, the assignment of the identifier may be static (i.e., the same identifier is assigned to the application 109 for the life of the application 109) or dynamic (i.e., the identifier is assigned to an application 109 as needed for a specific time or use). The platform 107 can then originate and route messaging traffic between messaging application 109 in carrier network A 101 and messaging device 117 in carrier network B 103 using the assigned identifier and known network routing infrastructure. For instance, if an MDN is used as an identifier for the application 109, known MDN-based network routing infrastructure may route the messaging traffic between messaging application 109 and messaging device 117 based on the assigned MDN. In contrast, it is noted that the traditional method for inter-carrier routing of messaging application traffic relies on a single central organization (i.e., the Common Short Code Administration (CSCA)) to assign a unique 5-6 digit common short code (CSC) to a messaging application for inter-carrier routing. To register a messaging application with the CSCA, a messaging application provider pays an initial registration fee and recurring monthly fees to the CSCA for each requested CSC. The messaging application provider then either contracts with a service aggregator or negotiates with individual wireless carriers to activate the CSC and route messaging traffic to the messaging application via the assigned CSC. This process can be costly and complex.

From the carrier's perspective, the messaging service enablement process can involve complicated provisioning to enable inter-carrier routing to the appropriate messaging application. Routing and connectivity testing between the messaging application and the carrier may be required before implementation of the messaging application. Moreover, CSCA rules can limit and, in some cases, prevent a service provider from enforcing the provider's messaging traffic policies. These rules and guidelines also can hinder a network's ability to accurately track messaging traffic to and from a messaging application. Failure to track messaging traffic and enforce appropriate policies may result in possible spamming or unintended messages to a network's subscribers.

To address these shortcomings, the inter-carrier messaging application platform 107 bypasses the CSC-based routing process and assigns a unique carrier-assigned identifier (e.g., MDN, MSISDN) to a messaging application 109 to enable use of existing routing infrastructure. By leveraging the use of known (or standard) infrastructure, exemplary embodiments of platform 107 can eliminate the need for special routing provisioning. Moreover, it is noted that communication service providers typically already own large blocks of identifiers suitable for assigning to applications (e.g., MDNs, MSISDNs), and using a portion of these identifiers to identify a messaging application 109 or service can be very cost effective. Ownership of the identifiers also enables a carrier to track and enforce messaging policies on messaging traffic terminating at the carrier.

As seen in FIG. 1, the inter-carrier messaging application platform 107 has access to a database 111 of carrier-assigned identifiers (e.g., MDNs) and a database 113 of messaging traffic policies. MDN database 111 stores information on the availability of carrier-assigned identifiers for use by platform 107 in assigning an identifier to a messaging application 109. Database 113 stores messaging traffic policies, which can include policies on security, spamming, legal use, messaging volume limits, temporal limits, or etc. It is contemplated that messaging traffic policies may be created by the carrier and/or the messaging application provider. In certain embodiments, platform 107 may enforce these policies on messaging traffic in real-time. The messaging services, as supported by the platform 107, include schedule announcement, mobile marketing/advertisement, emergency alerts, etc.

The inter-carrier messaging application platform 107 has connectivity to a messaging application 109 within carrier network A 101. It is also contemplated that messaging application 109 may include, for example, an application for voting/polling, marketing, gaming, etc., as well as applications that provide content from sources such news organizations, advertising agencies, promoters, etc. For example, messaging application 109 may operate on a data network (not shown) within carrier network A 101; the data network may be a local area network (LAN), metropolitan area network (MAN), wide area network (WAN), the Internet, or any other suitable packet-switched network (e.g., a proprietary cable or fiber-optic network).

Platform 107 can be accessed by a messaging device 117 located in carrier network B 103 through a direct connection or through inter-carrier routing network 105. The messaging device 117 may be any device configured to communicate over the network 101: a wireless application protocol (WAP) enabled cellular telephone, a home communication terminal (HCT), a digital home communication terminal (DHCT), a personal digital assistant (PDA), a television, a personal computer (PC), and/or customer premises equipment (CPE). In certain embodiments, inter-carrier routing network 105 can support both SMS and MMS messaging. The inter-carrier routing network 105 can include one or more messaging switches or routers such as, for example, an SMS router, a short message service center (SMSC), a multimedia messaging service center (MMSC), and/or similar devices.

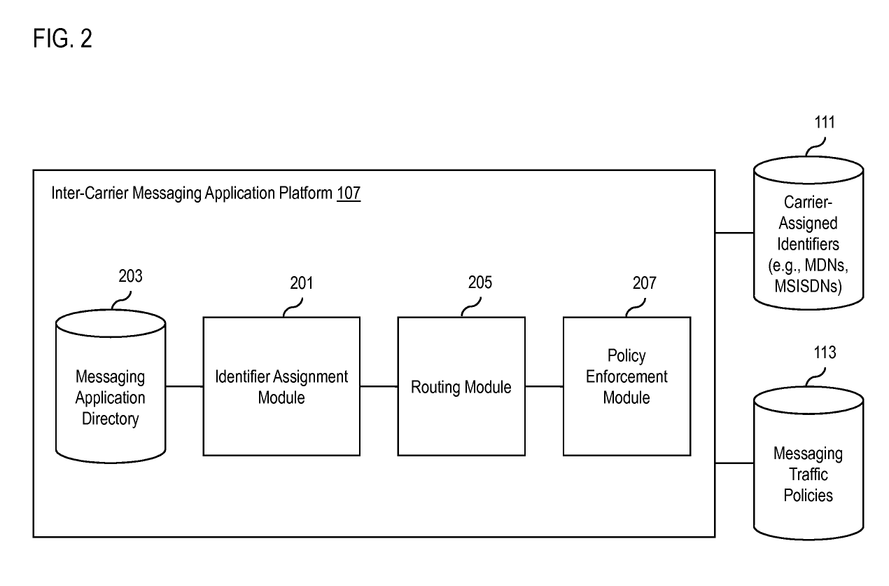

FIG. 2 is a diagram of the components of an inter-carrier messaging application platform, according to an exemplary embodiment. In this embodiment, the inter-carrier messaging application platform 107 includes: an identifier assignment module 201, a messaging application directory 203, a routing module 205, and a policy enforcement module 207. As discussed with respect to FIG. 1, platform 107 also has access to identifier database 111 and a database 113 of messaging traffic policies.

The identifier assignment module 201 interacts with identifier database 111 and messaging application directory 203 in responding to a request to assign an identifier (e.g., an MDN or an MSISDN) to a messaging application 109. In response to a request, the identifier assignment module 201 checks the identifier database 111 for an available identifier, assigns the identifier to the messaging application, and stores a record of the assignment in the messaging application directory 203. A record in the messaging application directory 203 may include, for example, the name of the application, assigned identifier, network location, and/or other information necessary to support a routing protocol employed by the carrier.

The routing module 205 operates in conjunction with messaging application directory 203 to ensure that inter-carrier messaging traffic routed to a carrier is directed to the appropriate messaging application or messaging device. In exemplary embodiments, known routing infrastructure (e.g., inter-carrier routing network 105) can be utilized to route messaging traffic from an originating carrier to a terminating carrier. In certain embodiments, messaging traffic may also be delivered via a direct connection between two networks. Once delivered to the recipient carrier's network, messaging traffic is routed to the appropriate messaging application or messaging device by routing module 205. In addition, routing module 205 can be configured to track the messaging traffic directed to a messaging application. It is contemplated, that routing module 205 may use any messaging protocol or interface for routing and tracking. It also is contemplated that routing module 205 may reside in or be replaced by known routing infrastructure.

The policy enforcement module 207 monitors messaging traffic between a messaging application 109 and a messaging device 117 for the purposes of enforcing messaging traffic policies stored in database 113. In some embodiments, module 207 may restrict or block messaging traffic that violates one or more of a carrier's messaging traffic policy. These messaging traffic policies, in an exemplary embodiment, can be set by the carrier and/or the messaging application provider. For example, a carrier may have a policy prohibiting a messaging application from sending messaging traffic to device users who did not specifically request information from the messaging application (e.g., unsolicited or spam messaging). In this case, the policy enforcement module 207 may detect this type of unsolicited messaging traffic and stop its delivery.

In a second example, a messaging application provider may specify that a particular messaging application may receive messaging traffic from users only for a set period of time (e.g., voting or polling during a live event). In this case, the policy enforcement module will deliver messaging traffic only during the specified time period and block messaging traffic at all other times. It is contemplated that other means of policy enforcement (e.g., providing notice, suspending service, etc.) may be employed by policy enforcement module 207.

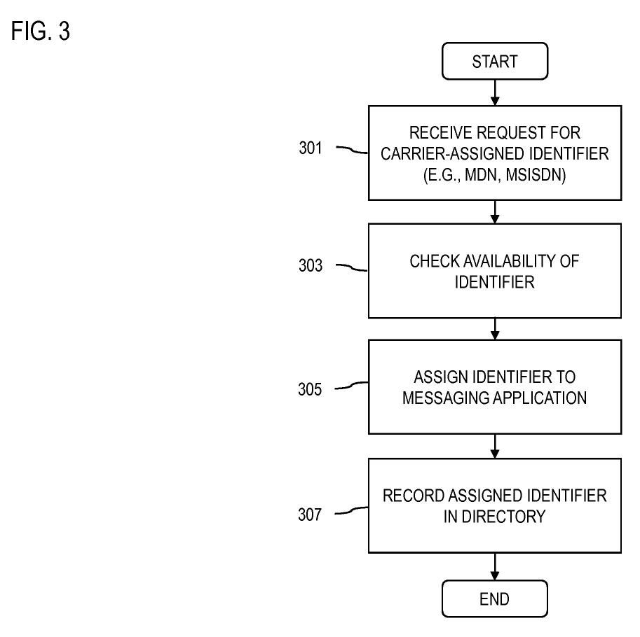

FIG. 3 is a flowchart of a process for assigning a carrier-assigned identifier to a messaging application, according to an exemplary embodiment. As discussed with respect to FIG. 1 above, the assignment of an identifier (e.g., MDN, MSISDN) may be either static or dynamic. In step 301, the inter-carrier messaging application platform 107 receives a request to assign an identifier to a messaging application 109. The request may include, for example, a request for the assignment of any available identifier or for the assignment of a specific identifier. If the request is for any available identifier, the platform 107 checks carrier—assigned identifier database 111 for an available identifier (step 303), assigns the identifier to messaging application 109 (step 305), and records the assignment in messaging application directory 203 (step 307) as previously described with respect to identifier assignment module 201. Platform 107 may use any procedure for selecting an available identifier (e.g., select the first available identifier, select an identifier from a reserved block of identifiers, select an identifier based on messaging application type, etc.). If the request is for a specific identifier, platform 107 checks identifier database 111 to determine whether the specified identifier is available (step 303). If available, the platform 107 will assign the identifier to messaging application 109 (step 305) and record the assignment in the messaging application directory 203 (step 307).

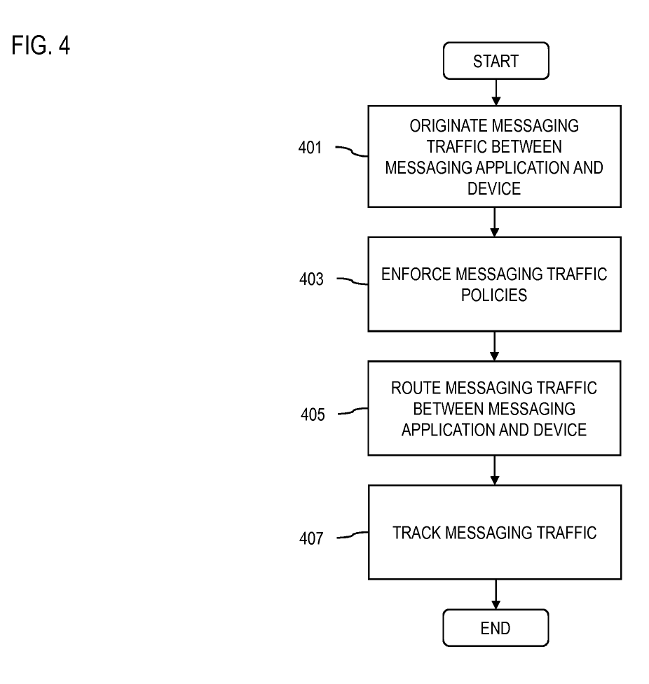

FIG. 4 is a flowchart of a process for routing inter-carrier messaging application traffic via a carrier-assigned identifier, according to an exemplary embodiment. In step 401, the inter-carrier messaging application platform 107 originates messaging traffic between messaging application 109 in carrier network A 101 and messaging device 117 in carrier network B 103. Platform 107 then examines the messaging traffic for compliance with pre-determined messaging traffic policies. If the messaging traffic violates any policies, platform 107 initiates the remedial action or actions specified in the applicable policy (e.g., prohibit violating messaging traffic) (step 403). In the next step, platform 107 routes the messaging traffic between messaging application 109 and messaging device 117 based on the specified identifier (e.g., MDN, MSISDN) (step 405) and creates a tracking log of the traffic to messaging application 109 (step 407).

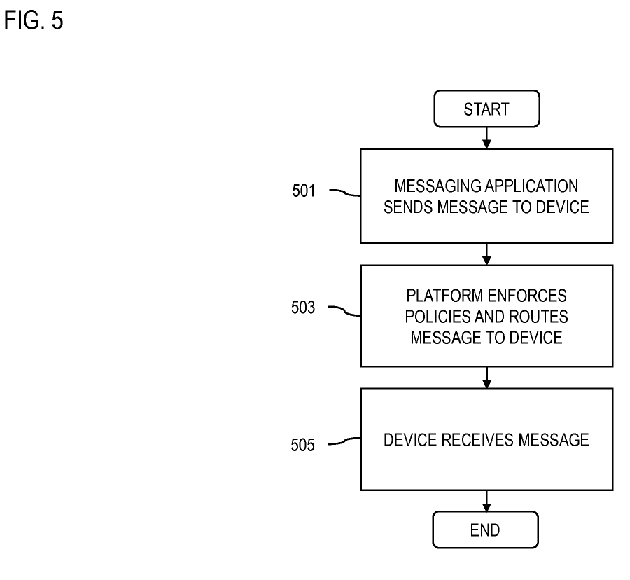

FIG. 5 is a flowchart of a process for sending messaging traffic from a messaging application, according to an exemplary embodiment. In step 501, the messaging application 109 residing in carrier network A 101 is directed to send a message to one or more devices (e.g., messaging device 117) in carrier network B 103. The inter-carrier messaging application platform 107 originates the messaging traffic, enforces relevant traffic policies, and routes the traffic to the specified messaging devices (503). The messaging traffic from messaging application 109 may be routed by, for example, the inter-carrier routing network 105. The messaging devices then receive the message from the messaging application per step 505.

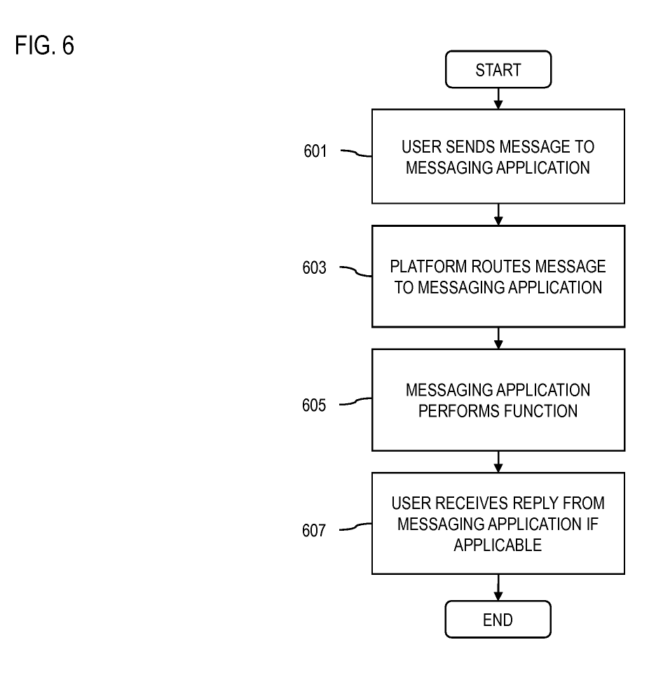

FIG. 6 is a flowchart of a process for interacting with an inter-carrier messaging application, according to an exemplary embodiment. In step 601, a user of messaging device 117 on carrier network B 103 sends a message addressed to the identifier (e.g., MDN, MSISDN) of messaging application 109 residing on carrier network A 101. The inter-carrier routing network 105, for instance, then routes the message to carrier network A 101 based on the specified identifier. Once the message reaches carrier network A 101, the inter-carrier messaging application platform 107 detects and completes the routing of the message to messaging application 109 (step 603) via the identifier. Messaging application 109 performs the function requested in the message (step 605) and provides any requested information or feedback to the user (step 607).

The processes described herein for routing inter-carrier messaging application traffic via a carrier-assigned identifier (e.g., MDN) may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

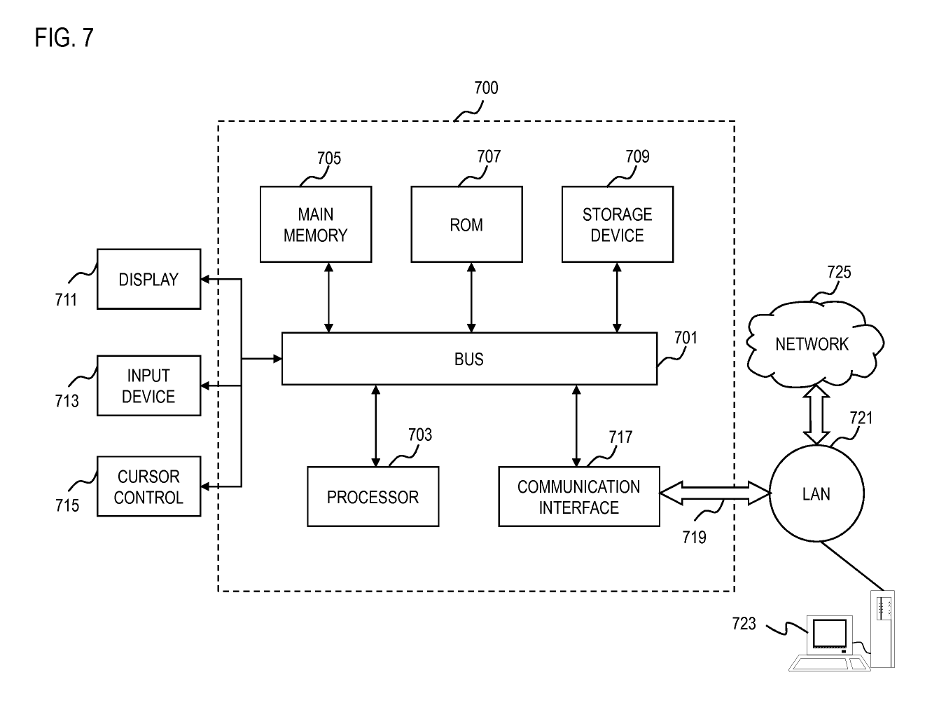

FIG. 7 illustrates computing hardware (e.g., computer system) upon which an embodiment according to the invention can be implemented. The computer system 700 includes a bus 701 or other communication mechanism for communicating information and a processor 703 coupled to the bus 701 for processing information. The computer system 700 also includes main memory 705, such as random access memory (RAM) or other dynamic storage device, coupled to the bus 701 for storing information and instructions to be executed by the processor 703. Main memory 705 also can be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
assigning a carrier-assigned identifier defined within a first carrier network to a messaging application;
originating messaging traffic between the messaging application and a device operating in a second carrier network; and
routing the messaging traffic between the messaging application and the device based on the carrier-assigned identifier.

2. A method of claim 1, wherein the first carrier network and the second carrier network are operated by respective communication service providers, and the carrier-assigned identifier includes a mobile directory number (MDN) or a mobile subscriber ISDN number (MSISDN).

3. A method of claim 1, wherein the messaging traffic is a short message service (SMS) or a multimedia messaging service (MMS) message.

4. A method of claim 1, further comprising:
retrieving a policy associated with the carrier-assigned identifier; and
applying the retrieved policy to the messaging traffic.

5. A method of claim 4, wherein the policy is set by an operator of the first carrier network, or a provider of the messaging application.

6. A method of claim 4, wherein the policy includes restricting spam or unintended messages.

7. A method of claim 4, wherein the messaging application includes one of schedule announcement, advertisement message, or emergency alerts.

8. A method of claim 1, further comprising:
tracking the messaging traffic for compliance with the policy.

9. A method of claim 1, further comprising:
receiving an allocation of a plurality of identifiers from an external entity.

10. An apparatus comprising:
a processor configured to assign a carrier-assigned identifier defined within a first carrier network to a messaging application, and to originate messaging traffic between the messaging application and a device operating in a second carrier network,
wherein the processor is further configured to initiate routing of the messaging traffic between the messaging application and the device based on the carrier-assigned identifier.

11. An apparatus of claim 10, wherein the first carrier network and the second carrier network are operated by respective communication service providers, and the carrier-assigned identifier includes a mobile directory number (MDN) or a mobile subscriber ISDN number (MSISDN).

12. An apparatus of claim 10, wherein the messaging traffic is a short message service (SMS) or a multimedia messaging service (MMS) message.

13. An apparatus of claim 10, wherein the processor is further configured to retrieve a policy associated with the carrier-assigned identifier, and to apply the retrieved policy to the messaging traffic.

14. An apparatus of claim 13, wherein the policy is set by an operator of the first carrier network, or a provider of the messaging application.

15. An apparatus of claim 13, wherein the policy includes restricting spam or unintended messages.

16. An apparatus of claim 13, wherein the messaging application includes one of schedule announcement, advertisement message, or emergency alerts.

17. An apparatus of claim 10, wherein the processor is further configured to tracking the messaging traffic for compliance with the policy.

18. An apparatus of claim 10, further comprising:
a communication interface configured to receive an allocation of a plurality of identifiers from an external entity.

19. A system comprising:
a database configured to store a plurality of policies; and
a platform configured to assign a carrier-assigned identifier defined within a first carrier network to a messaging application, to originate messaging traffic between the messaging application and a device operating in a second carrier network, and to route the messaging traffic between the messaging application and the device based on the carrier-assigned identifier,
wherein the platform is further configured to apply one or more of the policies to the messaging traffic based on the carrier-assigned identifier.

20. A system of claim 19, wherein at least one of the policies is set by an operator of the first carrier network, or a provider of the messaging application.
